(19) United States
(12) Patent Application Publication
(10) Pub. No.: US 2025/0112384 A1
(43) Pub. Date: Apr. 3, 2025

(54) CONNECTOR ASSEMBLY AND STRUCTURE COMPRISING THE SAME

(71) Applicant: JAPAN AVIATION ELECTRONICS INDUSTRY, LIMITED, Tokyo (JP)

(72) Inventor: Osamu HASHIGUCHI, Tokyo (JP)

(73) Assignee: JAPAN AVIATION ELECTRONICS INDUSTRY, LIMITED, Tokyo (JP)

(21) Appl. No.: 18/790,102

(22) Filed: Jul. 31, 2024

(30) Foreign Application Priority Data
Sep. 29, 2023 (JP) 2023-169047

(51) Int. Cl. H01R 12/70; H01R 24/50; H01R 103/00

(52) U.S. Cl. CPC H01R 12/7047; H01R 12/7064; H01R 24/50; H01R 2103/00

(57) ABSTRACT

A connector assembly comprises a coaxial connector, a fixed member and two fixing members. The coaxial connector comprises an outer terminal and a center terminal. The outer terminal has two projecting portions which are apart from each other in the lateral direction. The center terminal has a contact portion which is located between the two projecting portions in the lateral direction. The fixed member is located below the flexible board under a connected state where the connector assembly is connected to the flexible board. Under the connected state, the two fixing members are fixed to the two projecting portions, respectively, while pressing the flexible board, and thereby the contact portion of the center terminal is pressed against and is in contact with the signal line of the flexible board.

### CROSS REFERENCE TO RELATED APPLICATIONS

This application is based on and claims priority under 35 U.S.C. § 119 to Japanese Patent Application No. JP 2023-169047 filed Sep. 29, 2023, the content of which is incorporated herein in its entirety by reference.

### BACKGROUND OF THE INVENTION

This invention relates to a connector assembly comprising a coaxial connector configured to be attached to a coaxial cable.

For example, a coaxial connector configured to be attached to a coaxial cable is disclosed in JP2009-064588A (Patent Document 1), the content of which is incorporated herein by reference.

Referring to FIG. 20, Patent Document 1 discloses a coaxial connector 90 fixed to a case 94. The case 94 is provided with a board (circuit board) 96 located therein. As can be seen from FIG. 20, the board 96 is a rigid circuit board 96 which is hardly bent. The circuit board 96 is formed with a transmission line (signal line) 98. The coaxial connector 90 comprises a terminal portion (center terminal) 92. The center terminal 92 is electrically connected with the signal line 98 of the circuit board 96. The electrical connection as described above is usually performed by soldering the center terminal 92 to the signal line 98.

There is a demand for connecting the coaxial connector 90 to a thin, easily bendable flexible board instead of a circuit board which is hardly bent. However, the flexible board of some instances is made of material having low heat resistance. In these instances, it is difficult to solder the center terminal of the coaxial connector to the signal line of the flexible board. Moreover, when the center terminal is attempted to be pressed against the signal line instead of the soldering, the flexible board might be bent, and thereby sufficient contact pressure could not be obtained. As a result, contact reliability between the center terminal and the signal line might be lowered.

### SUMMARY OF THE INVENTION

It is therefore an object of the present invention to provide a configuration in which a coaxial connector is connected to a flexible board and which enables high contact reliability between a center terminal of a coaxial connector and a signal line of a flexible board.

An aspect of the present invention provides a connector assembly configured to be connected to a flexible board. The flexible board extends along a horizontal plane, the flexible board is formed with two passing holes. Each of the passing holes passes through the flexible board in an up-down direction perpendicular to the horizontal plane. The flexible board has an upper surface which is formed with a signal line. The signal line extends in a front-rear direction perpendicular to the up-down direction and is located between the two passing holes in a lateral direction perpendicular to both the up-down direction and the front-rear direction. The connector assembly comprises a coaxial connector, a fixed member and two fixing members. The coaxial connector is configured to be attached to a front end of a coaxial cable. The coaxial connector comprises an outer terminal, a center terminal and an insulation member. The insulation member insulates the outer terminal and the center terminal from each other. The outer terminal has an end surface and two projecting portions. The two projecting portions are apart from each other in the lateral direction and project forward from the end surface. The center terminal has a contact portion. The contact portion is located between the two projecting portions in the lateral direction and extends forward beyond the end surface. The fixed member has a pressed portion. The fixed member is located below the flexible board under a connected state where the connector assembly is connected to the flexible board. Under the connected state, the two fixing members are fixed to the two projecting portions of the outer terminal through the two passing holes of the flexible board, respectively, while pressing the pressed portion of the fixed member against a lower surface of a part of the flexible bard on which the signal line is formed, and thereby the contact portion of the center terminal is pressed against and is in contact with the signal line of the flexible board.

Another aspect of the present invention provides a structure comprising the connector assembly and the flexible board. The flexible board is located between the projecting portions and the fixed member in the up-down direction. The signal line of the flexible board is pressed by the fixed member from below and is pressed against the contact portion of the center terminal.

According to an aspect of the present invention, the center terminal of the coaxial connector can be pressed against and connected to the signal line of the flexible board with no soldering. The fixing members press the fixed member against the flexible board when the center terminal is connected to the signal line. The-thus pressed fixed member reduces the bending of a part of the flexible board located between the center terminal and the signal line, and thereby contact reliability between the center terminal and the signal line can be improved. Thus, an aspect of the invention provides a configuration in which the coaxial connector is connected to the flexible board and which enables high contact reliability between the center terminal and the signal line.

An appreciation of the objectives of the present invention and a more complete understanding of its configuration may be had by studying the following description of the preferred embodiment and by referring to the accompanying drawings.

### BRIEF DESCRIPTION OF THE DRAWINGS

FIG. 1 is a perspective view showing a connector assembly according to an embodiment of the present invention, wherein the connector assembly is under a pre-connected state where the connector assembly is not yet connected to a flexible board.

FIG. 2 is a perspective view showing the connector assembly of FIG. 1, wherein the connector assembly is under a connected state where the connector assembly is connected to the flexible board.

FIG. 3 is a top view showing the connector assembly of FIG. 2.

FIG. 4 is a side view showing the connector assembly of FIG. 2, wherein outlines of a hidden fixing hole, a hidden passing hole and a hidden screw hole are illustrated with dashed line.

FIG. 5 is a front view showing the connector assembly of FIG. 2, wherein outlines of the hidden fixing holes, the hidden passing holes and the hidden screw holes are illustrated with dashed line.

FIG. 6 is a cross-sectional view showing the connector assembly of FIG. 5, taken along line VI-VI, wherein a coaxial cable and a mating connector are partially illustrated with dashed line, a part of the connector assembly enclosed by chain dotted line is enlarged and illustrated, and in the enlarged view, an outline of a center terminal under the pre-connected state is illustrated with dashed line.

FIG. 7 is a perspective view showing a modification of the flexible board of FIG. 1.

FIG. 8 is a perspective view showing a modification of the connector assembly of FIG. 1, wherein the connector assembly is under the pre-connected state.

FIG. 9 is a perspective view showing the connector assembly of FIG. 8, wherein the connector assembly is under the connected state.

FIG. 10 is a front view showing the connector assembly of FIG. 9, wherein outlines of hidden fixing holes, hidden passing holes and hidden screw holes are illustrated with dashed line.

FIG. 11 is a cross-sectional view showing the connector assembly of FIG. 10, taken along line XI-XI, wherein a part of the connector assembly enclosed by dashed line is enlarged and illustrated.

FIG. 12 is a front view showing a part of the connector assembly enclosed by two-dot chain line A of FIG. 10, wherein a hidden part of a pressed portion of a fixed member is illustrated with dashed line.

FIG. 13 is a perspective view showing another modification of the connector assembly of FIG. 1, wherein the connector assembly is under the connected state.

FIG. 14 is a front view showing a part of the connector assembly of FIG. 13, wherein the illustrated part corresponds to the part illustrated in FIG. 12, and a hidden part of the pressed portion of the fixed member is illustrated with dashed line.

FIG. 15 is a perspective view showing still another modification of the connector assembly of FIG. 1, wherein the connector assembly is under the pre-connected state.

FIG. 16 is a perspective view showing the connector assembly of FIG. 15, wherein the connector assembly is under the connected state.

FIG. 17 is a side view showing the connector assembly of FIG. 16, wherein outlines of a hidden passing hole and a hidden press-fit hole are illustrated with dashed line.

FIG. 18 is a front view showing the connector assembly of FIG. 16, wherein outlines of the hidden passing holes and the hidden press-fit holes are illustrated with dashed line.

FIG. 19 is a cross-sectional view showing the connector assembly of FIG. 18, taken along line XIX-XIX.

FIG. 20 is a perspective view showing a coaxial connector, a case and a board of Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

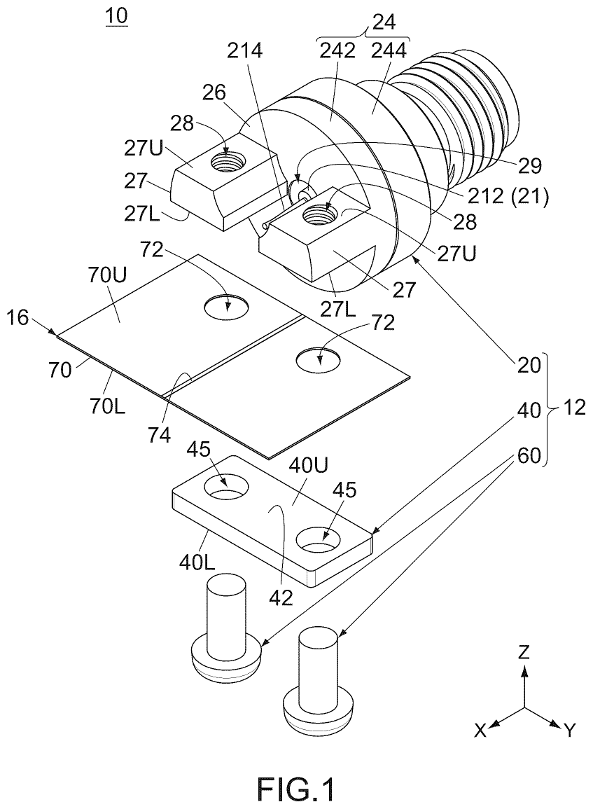

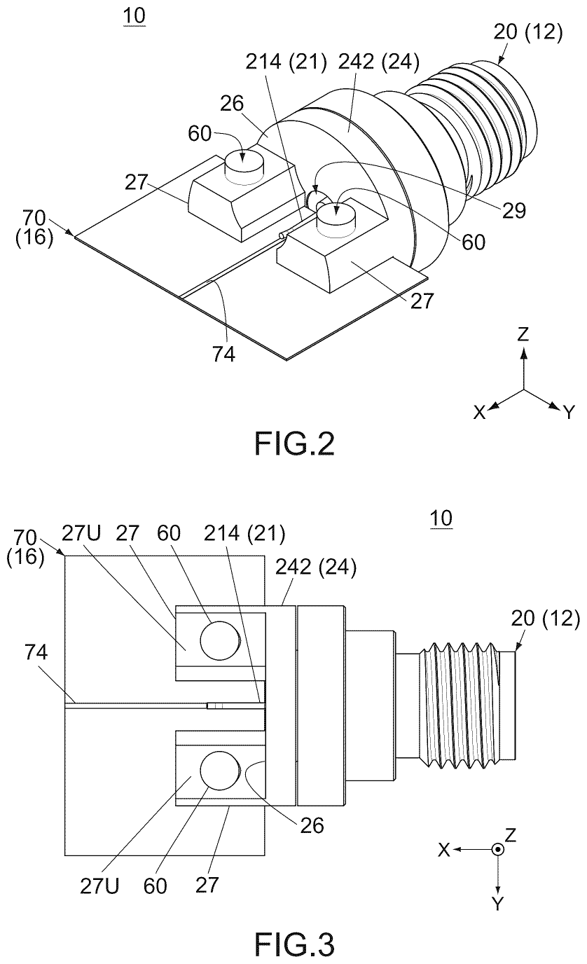

Referring to FIG. 1, a structure 10 according to an embodiment of the present invention comprises a connector assembly 12 and a flexible board 16. The flexible board 16 extends along a horizontal plane. As shown in FIG. 2, the connector assembly 12 is configured to be connected to the flexible board 16. In detail, the connector assembly 12 is configured to be connected to a rear end of the flexible board 16 in a front-rear direction in parallel to the horizontal plane. The connector assembly 12 of FIG. 2 is under a connected state where the connector assembly 12 is connected to the flexible board 16. The connector assembly 12 of FIG. 1 is under a pre-connected state where the connector assembly 12 is not yet connected to the flexible board 16.

The horizontal plane of the present embodiment is the XY-plane. The front-rear direction of the present embodiment is the X-direction. In the present embodiment, “forward” means the positive X-direction, and “rearward” means the negative X-direction. The words such as the horizontal plane and the front-rear direction do not indicate the absolute positional relation relative to the ground but merely indicate a relative positional relation under a definition where the flexible board 16 extends in the horizontal plane when not bent at all, and where the connector assembly 12 is located forward of this flexible board 16.

Referring to FIG. 1, the flexible board 16 comprises a base 70. The base 70 is formed of a thin film-like insulator having a thickness of about 0.1 mm. The illustrated flexible board 16 comprises only the base 70 except for various conductive patterns formed on the base 70. The flexible board 16 comprises no unbendable member such as a reinforcement plate configured to reinforce the base 70. The thus-formed flexible board 16 is easily bent when receiving a force. The easily bendable flexible board 16 can be flexibly arranged in a narrow space in an apparatus (not shown).

The flexible board 16 of the present embodiment is wholly thin and is easily bendable. However, the present invention is not limited thereto. For example, an unillustrated front part of the flexible board 16 may be reinforced by a reinforcement plate. Only the illustrated rear end of the flexible board 16 which is configured to be connected to the connector assembly 12 may be formed of only the thin and easily bendable base 70 and various conductive patterns.

The flexible board 16 has an upper surface 70U and a lower surface 70L in an up-down direction perpendicular to the horizontal plane. The upper surface 70U and the lower surface 70L are located at an upper end and a lower end of the base 70, respectively. The up-down direction of the present embodiment is the Z-direction. In the present embodiment, “upward” means the positive Z-direction, and “downward” means the negative Z-direction.

The flexible board 16 is formed with two passing holes 72. Each of the passing holes 72 passes through the flexible board 16 in the up-down direction. Each of the passing holes 72 has a circular shape in the horizontal plane. The thus-formed passing holes 72 are used when the connector assembly 12 is screwed to the flexible board 16 as described later. The two passing holes 72 are apart from each other in a lateral direction perpendicular to both the front-rear direction and the up-down direction and are located at positions same as each other in the front-rear direction. The lateral direction of the present embodiment is the Y-direction.

The passing holes 72 of the present embodiment are formed as described above. However, the present invention is not limited thereto. For example, the shape of each of the passing holes 72 is not specifically limited. Moreover, the number of the passing holes 72 may be three or more. In this instance, two of the passing holes 72 may be apart from each other in the lateral direction and may be located at positions same as each other in the front-rear direction.

The upper surface 70U of the flexible board 16 is formed with a signal line 74 which is a conductive pattern. The signal line 74 extends in the front-rear direction and is located between the two passing holes 72 in the lateral direction. The lower surface 70L of the flexible board 16 is formed with a ground layer (not shown) which is a conductive pattern and covers the whole of the lower surface 70L.

Referring to FIG. 2, the signal line 74 of an instance is connected to an antenna which is formed on an unillustrated front end part of the flexible board 16. In this instance, the connector assembly 12 under the connected state transmits signals to the antenna through the signal line 74. The thus-transmitted signals are sent outward from the antenna. On the other hand, signals received by the antenna are transmitted to the connector assembly 12 through the signal line 74. The structure 10 of the present embodiment is uses as described above, for example. In other words, the structure 10 of the present embodiment is an antenna device. However, the usage of the structure 10 of the present invention is not specifically limited. The structure 10 of the present invention may be any electric device with the flexible board 16.

The flexible board 16 of the present embodiment has the aforementioned configuration. However, the configuration of the flexible board 16 can be modified in accordance with the usage of the structure 10. For example, the ground layer (not shown) may be partially formed on the lower surface 70L.

Referring to FIG. 1, the connector assembly 12 of the present embodiment comprises a coaxial connector 20, a fixed member 40 made of metal and two fixing members (screws) 60 each made of metal. The connector assembly 12 of the present embodiment comprises only the aforementioned members. However, the present invention is not limited thereto. For example, the connector assembly 12 may further comprise another member in addition to the aforementioned members.

Hereafter, explanation will be made about the coaxial connector 20, the fixed member 40 and the fixing members 60 of the present embodiment in this order.

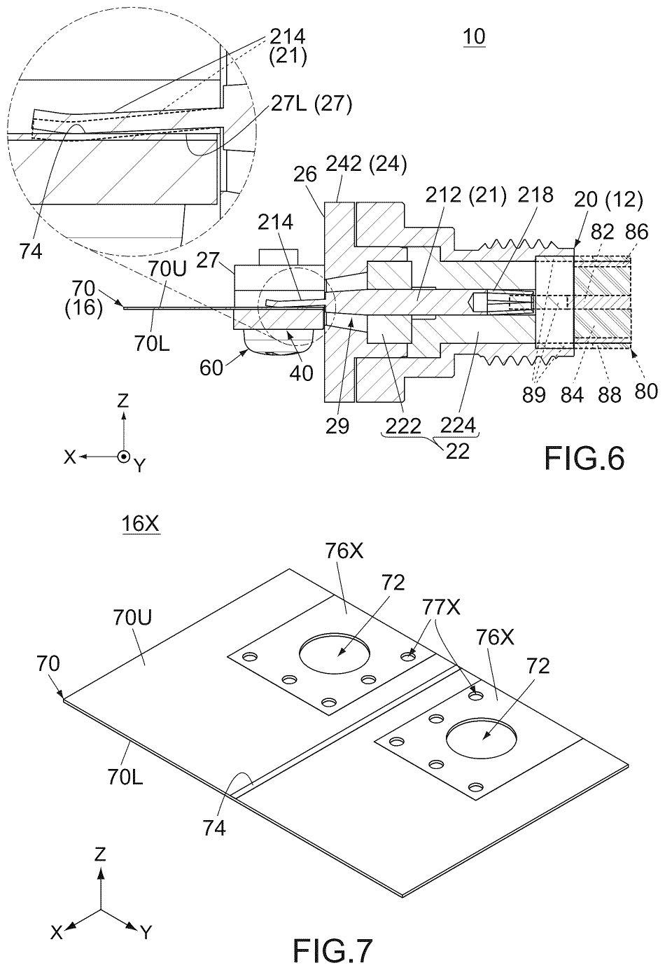

Referring to FIG. 6, the coaxial connector 20 of the present embodiment is configured to be attached to a front end of a coaxial cable 80. The coaxial connector 20 of the present embodiment is a so-called sub miniature type A (SMA) connector. However, the present invention is not limited thereto but applicable to various coaxial connectors 20.

The coaxial cable 80 illustrated with dashed line is a typical coaxial cable and comprises a core wire 82 made of conductor, an inner insulator 84 made of insulator and covering the core wire 82, a shield 86 made of conductor and covering the inner insulator 84 and a sheath 88 made of insulator and covering the shield 86. The number of the core wire 82 of the present embodiment is one. The configuration of the coaxial cable 80 is not specifically limited, provided that the number of the core wire 82 is one. For example, the shield 86 may be a braid formed of fine metal wires or may be made of metal foil. For example, the coaxial cable 80 may be connected to a rear end of the coaxial connector 20 via a mating connector 89 attached to the coaxial cable 80.

Referring to FIG. 6 together with FIG. 1, the coaxial connector 20 of the present embodiment comprises a center terminal 21 made of conductor, an insulation member 22 made of insulator and an outer terminal 24 made of conductor. The coaxial connector 20 of the present embodiment comprises only the aforementioned members. However, the present invention is not limited thereto. For example, the coaxial connector 20 may further comprise another member in addition to the aforementioned members.

As shown in FIG. 6, the center terminal 21 of the present embodiment extends along the front-rear direction and has a body 212, a contact portion 214 and a connection portion 218. The body 212 is a middle part of the center terminal 21 in the front-rear direction. The contact portion 214 extends forward from the body 212. The connection portion 218 has a socket shape and extends rearward from the body 212. The center terminal 21 is electrically connected with the core wire 82 of the coaxial cable 80 when the coaxial connector 20 is attached to the coaxial cable 80. In detail, the connection portion 218 of the center terminal 21 is configured to be electrically connected with the core wire 82. The center terminal 21 and the core wire 82 connected to each other transmit signals to each other.

The center terminal 21 of the present embodiment has the aforementioned configuration. However, the configuration of the center terminal 21 can be modified as necessary, provided that the center terminal 21 has the contact portion 214 which extends along the front-rear direction.

The insulation member 22 of the present embodiment comprises a front insulation member 222 and a rear insulation member 224. The front insulation member 222 is combined with the rear insulation member 224 and is located forward of the rear insulation member 224. The insulation member 22 of the present embodiment consists of the aforementioned two members. However, the present invention is not limited thereto. For example, the front insulation member 222 and the rear insulation member 224 may be a member integrally formed with each other.

As shown in FIGS. 1 and 6, the outer terminal 24 of the present embodiment comprises a front conductive member 242 and a rear conductive member 244. The front conductive member 242 is combined with the rear conductive member 244 and is located forward of the rear conductive member 244. The front conductive member 242 is in contact with the rear conductive member 244. The outer terminal 24 of the present embodiment consists of the aforementioned two members. However, the present invention is not limited thereto. For example, the front conductive member 242 and the rear conductive member 244 may be a member integrally formed with each other.

Referring to FIG. 6, the outer terminal 24 is electrically connected with the shield 86 of the coaxial cable 80 when the coaxial connector 20 is attached to the coaxial cable 80. In detail, the rear conductive member 244 of the outer terminal 24 is configured to be electrically connected with the shield 86. The outer terminal 24 and the shield 86 connected to each other have ground potentials same as each other.

The insulation member 22 encloses the body 212 and the connection portion 218 of the center terminal 21 except for a front end part of the body 212 in a vertical plane (YZ-plane) perpendicular to the front-rear direction. The outer terminal 24 encloses the front end part of the body 212 in the YZ-plane with a distance formed therebetween and encloses the insulation member 22 in the YZ-plane. The thus-arranged insulation member 22 is located between the center terminal 21 and the outer terminal 24 in the YZ-plane. In other words, the insulation member 22 insulates the outer terminal 24 and the center terminal 21 from each other. The center terminal 21, the insulation member 22 and the outer terminal 24 of the present embodiment are arrange as described above. However, the arrangement of the center terminal 21, the insulation member 22 and the outer terminal 24 is not specifically limited, provided that the outer terminal 24 and the center terminal 21 are insulated from each other by the insulation member 22.

As shown in FIGS. 1, 3 and 5, the outer terminal 24 has an end surface 26 and two projecting portions 27. The end surface 26 of the present embodiment is a front surface of the front conductive member 242 and a flat circular surface in parallel to the YZ-plane. The two projecting portions 27 are apart from each other in the lateral direction and project forward from the end surface 26. The two projecting portions 27 of the present embodiment have a mirror symmetric shape with respect to a predetermined plane (XZ-plane). The thus-arranged two projecting portions 27 are located at positions same as each other in the up-down direction. Each of the two projecting portions 27 has a rectangular flat-plate shape in parallel to the horizontal plane and has an upper surface 27U and a lower surface 27L. Each of the upper surfaces 27U and the lower surfaces 27L is a flat surface in parallel to the horizontal plane.

As shown in FIGS. 1 and 5, the outer terminal 24 of the present embodiment is formed with a center hole 29. The center hole 29 has a circular shape in the YZ-plane. The center hole 29 is located at the center of the end surface 26 in the YZ-plane and opens forward. The two projecting portions 27 are located at opposite sides of the end surface 26, respectively, with the center hole 29 located therebetween. The center terminal 21 is located at the center of the center hole 29 in the YZ-plane. The body 212 of the center terminal 21 has a circular shape in the YZ-plane. The contact portion 214 of the center terminal 21 has a circular shape which is smaller than that of the body 212 in the YZ-plane.

Referring to FIG. 6, the center hole 29 extends from the end surface 26 to a front end of the front insulation member 222 in the front-rear direction. The front end part of the body 212 of the center terminal 21 is located in the center hole 29. The contact portion 214 of the center terminal 21 is located forward of the end surface 26. Referring to FIG. 3, the contact portion 214 is located between the two projecting portions 27 in the lateral direction and extends forward beyond the end surface 26.

The end surface 26, the projecting portions 27 and the contact portion 214 of the present embodiment have the aforementioned configurations and are arranged as described above. However, the present invention is not limited thereto, but the configurations and the arrangement of the end surface 26, the projecting portions 27 and the contact portion 214 can be modified as necessary.

As shown in FIG. 1, each of the projecting portions 27 of the present embodiment is formed with a screw hole 28. Each of the screw holes 28 of the present embodiment passes through the projecting portion 27 in the up-down direction. The screw holes 28 are provided at positions which correspond to those of the passing holes 72 of the flexible board 16 in the horizontal plane, respectively. The thus-arranged two screw holes 28 are apart from each other in the lateral direction and are located at positions same as each other in the front-rear direction. The number of the screw holes 28 of the present embodiment is two. However, the present invention is not limited thereto. For example, each of the projecting portions 27 may be formed with two or more of the screw holes 28. Each of the screw holes 28 may be a hole with a ceiling.

The fixed member 40 of the present embodiment has a rectangular flat-plate shape in parallel to the horizontal plane. In the horizontal plane, the fixed member 40 has long sides each extending in the lateral direction and short sides each extending in the front-rear direction. The fixed member 40 has an upper surface 40U and a lower surface 40L. Each of the upper surface 40U and the lower surface 40L of the present embodiment is a flat surface in parallel to the horizontal plane.

The fixed member 40 has a pressed portion 42. As described later, the pressed portion 42 is a part which is configured to be pressed against the flexible board 16 under the connected state (see FIG. 5). According to the present embodiment, a middle part of the upper surface 40U in the lateral direction mainly works as the pressed portion 42.

The fixed member 40 of the present embodiment is formed with two fixing holes 45. Each of the fixing holes 45 passes through the fixed member 40 in the up-down direction. Each of the fixing holes 45 has a circular shape in the horizontal plane. The fixing holes 45 are provided at positions which correspond to those of the passing holes 72 of the flexible board 16 in the horizontal plane, respectively. The thus-arranged two fixing holes 45 are apart from each other in the lateral direction and are located at positions same as each other in the front-rear direction.

The fixed member 40 of the present embodiment has the aforementioned configuration. However, the present invention is not limited thereto. For example, the shape of each of the fixing holes 45 is not specifically limited. Moreover, the number of the fixing holes 45 may be three or more.

The two fixing members 60 of the present embodiment have shapes same as each other. More specifically, each of the fixing members 60 of the present embodiment is a screw 60. Accordingly, each of the fixing members 60 is formed with a thread (not shown). The fixing members 60 are provided so that they correspond to the passing holes 72 of the flexible board 16, respectively. Accordingly, the number of the fixing members 60 of the present embodiment is two. However, the present invention is not limited thereto. For example, the connector assembly 12 may be provided with three or more of the fixing members 60 which have shapes different from each other.

Referring to FIG. 1, the connector assembly 12 of the present embodiment is configured to be connected to the flexible board 16 by a connection method described below. The connection method described below is merely an example and can be modified as necessary.

Firstly, the coaxial connector 20, the flexible board 16 and the fixed member 40 are arranged from top to bottom in this order while the screw holes 28 of the coaxial connector 20, the passing holes 72 of the flexible board 16 and the fixing holes 45 of the fixed member 40 are arranged at positions same as each other in the horizontal plane. Then, each of the fixing members 60 is screwed into the screw hole 28 through the fixing hole 45 and the passing hole 72.

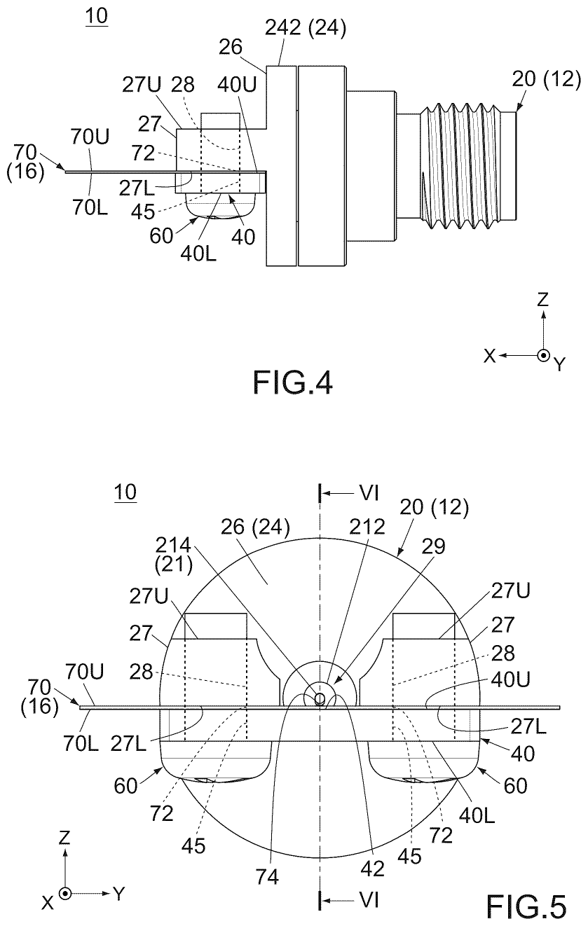

Referring to FIGS. 4 and 5, as a result of the aforementioned screwing, the flexible board 16 is sandwiched and held between the lower surfaces 27L of the two projecting portions 27 of the coaxial connector 20 and the upper surface 40U of the fixed member 40 in the up-down direction. Referring to FIG. 3, the thus-arranged connector assembly 12 is under the connected state shown in FIGS. 2 to 6, and the contact portion 214 of the center terminal 21 is located just over the signal line 74 of the flexible board 16.

Referring to FIG. 5, the fixed member 40 is located below the flexible board 16 under the connected state. Under the connected state, the head of each of the fixing members 60 is pressed against the lower surface 40L of the fixed member 40 which is in parallel to the horizontal plane and presses the fixed member 40 upward. The upper surface 40U of the thus-pressed fixed member 40 extends in parallel to the horizontal plane and presses the flexible board 16 against the lower surfaces 27L of the projecting portions 27 which are in parallel to the horizontal plane. As a result, the flexible board 16 is sandwiched and held between the projecting portions 27 and the fixed member 40 while keeping its posture in which the flexible board 16 extends in parallel to the horizontal plane. The thus-sandwiched flexible board 16 has a contact region which is located under the contact portion 214 of the center terminal 21. The pressed portion 42 of the fixed member 40 is pressed against the contact region of the flexible board 16 and supports the contact region from below. The thus-supported contact region of the flexible board 16 is not bent even when a force is applied thereto from above.

Referring to FIGS. 3 and 5, the contact portion 214 of the center terminal 21 is brought into contact with the signal line 74 of the flexible board 16 under the connected state. Referring to FIG. 6, the contact portion 214 of the center terminal 21 of the present embodiment is bent downward, for example, after the coaxial connector 20 is assembled. The thus-bent contact portion 214 extends forward and downward under the pre-connected state shown in FIG. 1. A lower end of the contact portion 214 is located below the lower surfaces 27L of the projecting portions 27 under the pre-connected state. The thus-formed contact portion 214 is brought into abutment with the signal line 74 of the flexible board 16 and is resiliently deformed under the connected state shown in FIG. 6. This resilient deformation generates a restoring force which presses the contact portion 214 against the signal line 74, which is supported to be unbendable, from above.

Summarizing the explanation described above, under the connected state, the two fixing members 60 are fixed to the two projecting portions 27 of the outer terminal 24 through the two passing holes 72 of the flexible board 16, respectively, while pressing the pressed portion 42 of the fixed member 40 against the lower surface 70L of a part of the flexible board 16 on which the signal line 74 is formed, and thereby the contact portion 214 of the center terminal 21 is pressed against and is brought into contact with the signal line 74 of the flexible board 16.

As can be seen from the aforementioned mechanism, according to the present embodiment, the center terminal 21 of the coaxial connector 20 can be pressed against and connected to the signal line 74 of the flexible board 16 with no soldering. The fixing members 60 press the fixed member 40 against the flexible board 16 when the center terminal 21 is connected to the signal line 74. The thus-pressed fixed member 40 reduces the bending of a part of the flexible board 16 located between the center terminal 21 and the signal line 74, and thereby contact reliability between the center terminal 21 and the signal line 74 can be improved. Thus, the present embodiment provides a configuration in which the coaxial connector 20 is connected to the flexible board 16 and which enables high contact reliability between the center terminal 21 and the signal line 74.

According to the present embodiment, the pressed portion 42 of the fixed member 40 is located between the two fixing holes 45 in the lateral direction. Moreover, as previously described, each of the fixing members 60 is screwed into the screw hole 28 through the fixing hole 45 of the fixed member 40 and the passing hole 72 of the flexible board 16 under the connected state. The pressed portion 42 can be stably pressed against the flexible board 16 in a simple manner according to this connection method. Thus, the contact reliability between the center terminal 21 and the signal line 74 can be further improved. However, the present invention is not limited thereto, but the connection method of the connector assembly 12 can be modified as necessary.

Referring to FIG. 4, the outer terminal 24 is grounded to the ground layer (not shown) of the lower surface 70L of the flexible board 16 via the projecting portions 27, the fixing members 60 and the fixed member 40 under the connected state. However, the present invention is not limited thereto. For example, referring to FIG. 7 together with FIG. 1, a flexible board 16X may be used instead of the flexible board 16.

The flexible board 16X according to a modification comprises two lands 76X each of which is a conductive pattern and which are not provided on the flexible board 16. The two passing holes 72 pass through the lands 76X, respectively. Each of the lands 76X is formed with a plurality of via holes 77X. Each of the via holes 77X passes through the base 70 and the land 76X in the up-down direction, and thereby each of the lands 76X is electrically connected with the ground layer (not shown) of the lower surface 70L. Referring to FIG. 7 together with FIG. 4, the outer terminal 24 under the connected state can be grounded to the ground layer of the flexible board 16X via the projecting portions 27 and the lands 76X by using the flexible board 16X.

Referring to FIG. 5, the connector assembly 12 forms the structure 10 together with the flexible board 16 connected thereto. The flexible board 16 of the structure 10 is located between the projecting portions 27 of the outer terminal 24 and the fixed member 40 in the up-down direction. The signal line 74 of the flexible board 16 is pressed by the fixed member 40 from below and is pressed against the contact portion 214 of the center terminal 21.

The structure 10 of the present embodiment can be further variously modified in addition to the already explained various modifications. Hereafter, explanation will be made about three modifications of the structure 10, focusing on differences from the structure 10.

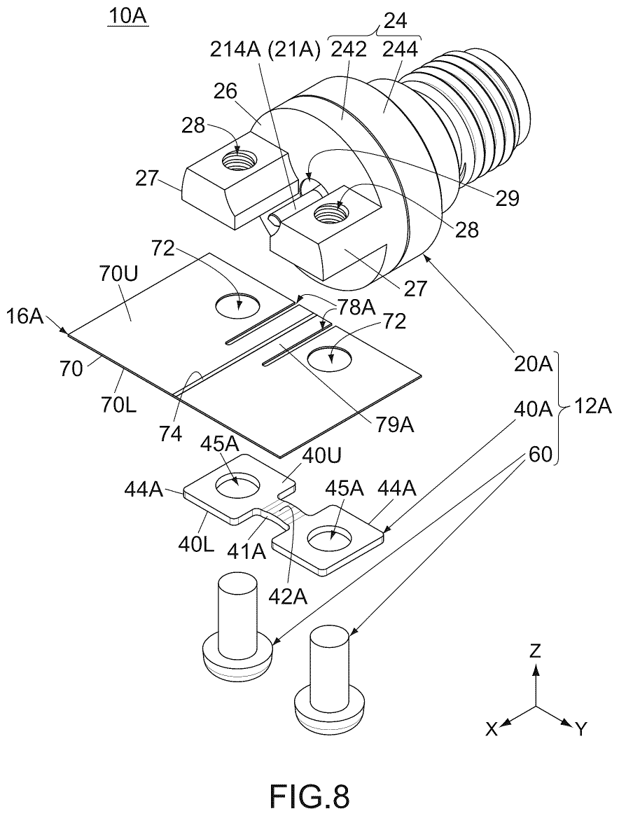

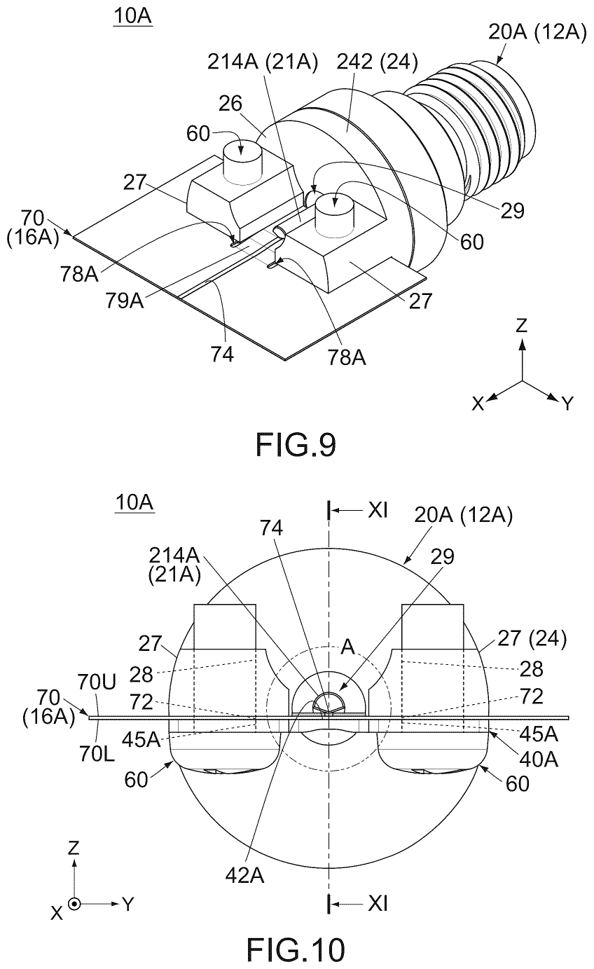

Comparing FIG. 8 with FIG. 1, a structure 10A according to a first modification comprises a connector assembly 12A different from the connector assembly 12 and a flexible board 16A different from the flexible board 16. Comparing FIG. 9 with FIG. 2, the connector assembly 12A is configured to be connected to the flexible board 16A similarly to the connector assembly 12.

Comparing FIG. 8 with FIG. 1, the flexible board 16A has a configuration similar to that of the flexible board 16. For example, the flexible board 16A extends along the horizontal plane (XY-plane). The flexible board 16A is formed with two passing holes 72. Each of the passing holes 72 passes through the flexible board 16A in the up-down direction (Z-direction). The flexible board 16A has an upper surface 70U which is formed with a signal line 74. The signal line 74 extends in the front-rear direction (X-direction) and is located between the two passing holes 72 in the lateral direction (Y-direction).

The flexible board 16A is formed with two slits 78A which are not formed in the flexible board 16. Each of the slits 78A is a cut which passes through the flexible board 16A in the up-down direction. The two slits 78A are apart from each other in the lateral direction. Each of the slits 78A extends forward from a rear edge of the flexible board 16A. The signal line 74 is located between the two slits 78A in the lateral direction and extends in the front-rear direction.

The flexible board 16A has a bendable portion 79A. The bendable portion 79A is a part of the flexible board 16A which is located between the two slits 78A in the lateral direction. The thus-arranged bendable portion 79A is easily bendable. The bendable portion 79A extends forward from the rear edge of the flexible board 16A. The signal line 74 is located at the middle of the bendable portion 79A in the lateral direction.

The connector assembly 12A comprises a coaxial connector 20A different from the coaxial connector 20, a fixed member 40A different from the fixed member 40 and the two fixing members 60 same as those of the connector assembly 12. Thus, each of the fixing members 60 is the screw 60.

The coaxial connector 20A comprises a center terminal 21A different from the center terminal 21. The coaxial connector 20A has the configuration same as that of the coaxial connector 20 except for the center terminal 21A. The center terminal 21A has a contact portion 214A different from the contact portion 214. The center terminal 21A has the configuration same as that of the center terminal 21 except for the contact portion 214A.

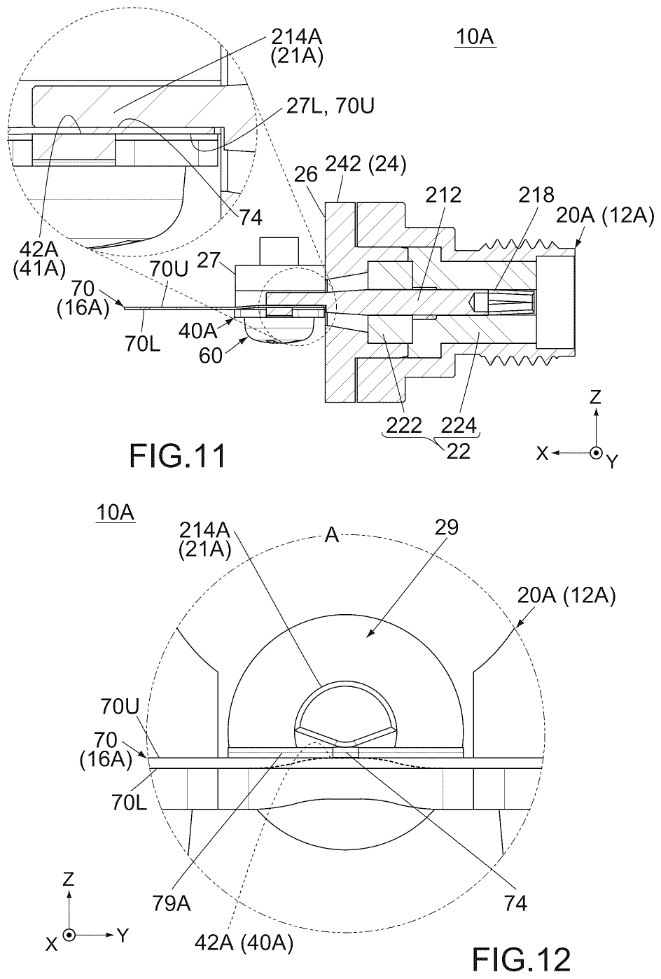

Referring to FIG. 11 together with FIG. 6, the coaxial connector 20A is configured to be attached to the front end of the coaxial cable 80. Referring to FIG. 11, the coaxial connector 20A comprises the outer terminal 24, the center terminal 21A and the insulation member 22. The insulation member 22 insulates the outer terminal 24 and the center terminal 21A from each other. As shown in FIG. 8, the outer terminal 24 has the end surface 26 and the two projecting portions 27. The two projecting portions 27 are apart from each other in the lateral direction and project forward from the end surface 26. Each of the projecting portions 27 is formed with the screw hole 28. The contact portion 214A of the center terminal 21A is located between the two projecting portions 27 in the lateral direction and extends forward beyond the end surface 26.

Referring to FIGS. 10 and 12, the contact portion 214A of the center terminal 21A has a fan shape in the YZ-plane perpendicular to the front-rear direction. The shape of the contact portion 214A is different from that of the contact portion 214 (see FIG. 5) of the center terminal 21 in the aforementioned feature. In detail, the upper part of the contact portion 214A has an arc-like shape which projects upward, and the lower part of the contact portion 214A has a triangle shape which projects downward. The thus-formed contact portion 214A has a lower end which projects downward. Referring to FIG. 11, the lower end of the contact portion 214A is located slightly above the lower surfaces 27L of the projecting portions 27 under a pre-connected state where the connector assembly 12A is not yet connected to the flexible board 16A as shown in FIG. 8.

Referring to FIG. 8, the fixed member 40A is a single metal plate with bends. The fixed member 40A has a coupling portion 41A, a pressed portion 42A and two side portions 44A. Moreover, the fixed member 40A has an upper surface 40U and a lower surface 40L. Each of the side portions 44A has a rectangular flat-plate shape in parallel to the horizontal plane. Each of the upper surface 40U and the lower surface 40L of each of the thus-formed side portions 44A is a flat surface in parallel to the horizontal plane. The two side portions 44A are located at opposite sides of the fixed member 40A in the lateral direction, respectively. The coupling portion 41A couples the two side portions 44A together in the lateral direction.

According to the present modification, a middle part of the upper surface 40U of the coupling portion 41A in the lateral direction works as the pressed portion 42A. The pressed portion 42A protrudes upward. More specifically, the pressed portion 42A has an arc-like shape which projects upward in the YZ-plane. The pressed portion 42A has an upper end which is located above the upper surfaces 40U of the side portions 44A.

Comparing FIG. 8 with FIG. 1, each of the side portions 44A is formed with a fixing hole 45A. Thus, the fixed member 40A is formed with the two fixing holes 45A. Each of the fixing holes 45A has a size which is smaller than that of the fixing hole 45 in the up-down direction. The fixing holes 45A have configurations similar to those of the fixing holes 45 and are arranged similarly to the fixing holes 45 except for this difference. For example, each of the fixing holes 45A passes through the fixed member 40A in the up-down direction. The fixing holes 45A are provided at positions which correspond to those of the passing holes 72 of the flexible board 16A in the horizontal plane, respectively.

Referring to FIGS. 10 and 11 together with FIG. 12, the connector assembly 12A is configured to be connected to the flexible board 16A by a connection method similar to that of the connector assembly 12 (see FIG. 2), or by the screwing with the screws 60.

The fixed member 40A is located below the flexible board 16A under a connected state where the connector assembly 12A is connected to the flexible board 16A. Under the connected state, the two fixing members 60 are fixed to the two projecting portions 27 of the outer terminal 24 through the two passing holes 72 of the flexible board 16A, respectively, while pressing the pressed portion 42A of the fixed member 40A against the lower surface 70L of a part of the flexible board 16A on which the signal line 74 is formed, and thereby the contact portion 214A of the center terminal 21A is pressed against and is brought into contact with the signal line 74 of the flexible board 16A.

Referring to FIG. 12 together with FIG. 8, under the connected state, the upper end of the pressed portion 42A of the present modification is pressed against the lower surface 70L of a part of the bendable portion 79A of the flexible board 16A on which the signal line 74 is formed. The bendable portion 79A is bent so as to protrude upward when an upward force is applied thereto from the pressed portion 42A. As a result, the signal line 74 formed on the bendable portion 79A is moved upward. Meanwhile, the pressed portion 42A is resiliently deformed downward. The signal line 74 which is moved upward is pressed against the contact portion 214A of the center terminal 21A of the coaxial connector 20A. The present modification, similarly to the previously described embodiment, provides a configuration in which the coaxial connector 20A is connected to the flexible board 16A and which enables high contact reliability between the center terminal 21A and the signal line 74.

According to the present modification, the downward projecting lower end of the fan shape of the contact portion 214A of the center terminal 21A is pressed against the signal line 74 which is moved upward. Accordingly, the contact reliability between the center terminal 21A and the signal line 74 can be improved without bending the contact portion 214A downward. Moreover, the fan-like contact portion 214A can be reliably in contact with the signal line 74 even if the front conductive member 242 of the outer terminal 24 rotates beyond a designed position in the YZ-plane by an angle within a predetermined range during a process of combining the front conductive member 242 with the rear conductive member 244. However, the present invention is not limited thereto. For example, the contact portion 214A may extend forward and downward under the pre-connected state shown in FIG. 8.

Referring to FIG. 10, according to the present modification, the pressed portion 42A of the fixed member 40A is located between the two fixing holes 45A in the lateral direction similarly to the previously described embodiment. Similarly to the previously described embodiment, each of the fixing members 60 is screwed into the screw hole 28 of the projecting portion 27 through the fixing hole 45A of the fixed member 40A and the passing hole 72 of the flexible board 16A under the connected state. The pressed portion 42A can be stably pressed against the flexible board 16A in a simple manner according to this connection method.

The connector assembly 12A forms the structure 10A together with the flexible board 16A connected thereto. The flexible board 16A of the structure 10A is located between the projecting portions 27 of the outer terminal 24 and the fixed member 40A in the up-down direction. The upward protruding pressed portion 42A of the fixed member 40A is pressed against a part of the flexible board 16A which corresponds to the signal line 74 in the front-rear direction. As a result, the signal line 74 of the flexible board 16A is pressed by the fixed member 40A from below and is pressed against the contact portion 214A of the center terminal 21A.

According to the present modification, the fixed member 40A can be reduced in size in the up-down direction. Thus, according to the present modification, the contact reliability between the center terminal 21A and the signal line 74 can be improved while the structure 10A is reduced in height.

Referring to FIG. 1 together with FIG. 8, the structure 10 of the previously described embodiment may also comprise the flexible board 16A instead of the flexible board 16. However, no specific effects can be obtained unless the fixed member 40 is provided with a part such as the upward protruding pressed portion 42A of the fixed member 40A. In other words, in an instance in which the bendable portion 79A such as that of the flexible board 16A is provided, the upward protruding pressed portion 42A is preferred to be provided. In an instance in which the upward protruding pressed portion 42A is provided, the bendable portion 79A is preferred to be provided.

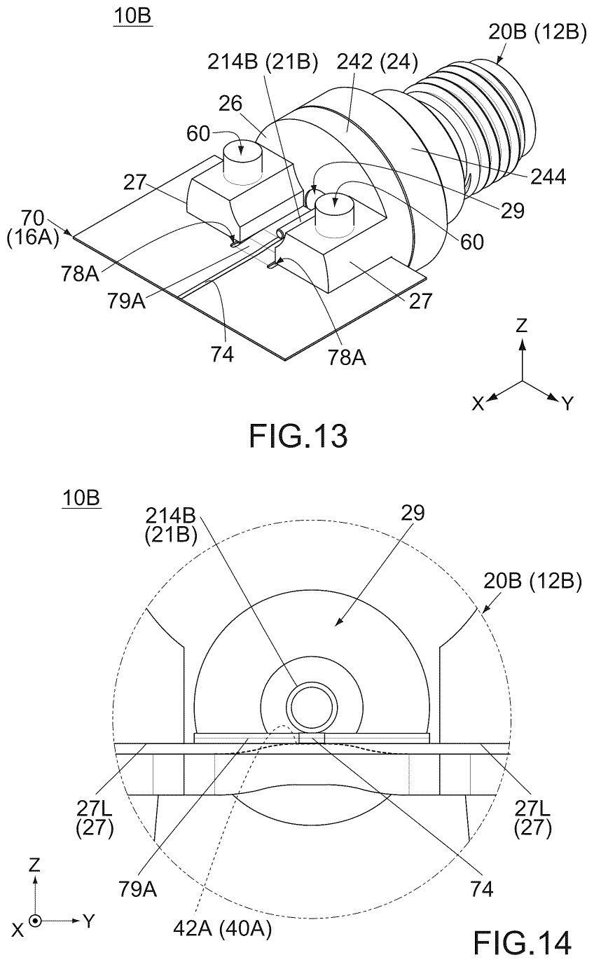

Comparing FIGS. 13 and 14 with FIGS. 9 and 12, a structure 10B according to a second modification comprises a connector assembly 12B different from the connector assembly 12A and the flexible board 16A same as that of the structure 10A. The connector assembly 12B comprises a coaxial connector 20B different from the coaxial connector 20A and comprises the fixed member 40A and the two fixing members 60 same as those of the connector assembly 12A. The coaxial connector 20B comprises a center terminal 21B different from the center terminal 21A of the coaxial connector 20A. The coaxial connector 20B has the configuration same as that of the coaxial connector 20A except for the center terminal 21B. The center terminal 21B has a contact portion 214B different from the contact portion 214A of the center terminal 21A. The center terminal 21B has the configuration same as that of the center terminal 21A except for the contact portion 214B.

Referring to FIGS. 13 and 14, the contact portion 214B has a cylindrical shape extending in the front-rear direction. The thus-formed contact portion 214B has a circular shape in the YZ-plane perpendicular to the front-rear direction. The connector assembly 12B according to the present modification is configured to be connected to the flexible board 16A by the connection method same as that of the connector assembly 12A (see FIG. 9). The present modification, similarly to the first modification, provides a configuration in which the coaxial connector 20B is connected to the flexible board 16A and which enables high contact reliability between the center terminal 21B and the signal line 74.

According to the present modification, the contact reliability between the center terminal 21B and the signal line 74 can be improved without bending the contact portion 214B downward similarly to the first modification. Moreover, the cylindrical contact portion 214B can be reliably in contact with the signal line 74 even if the front conductive member 242 of the outer terminal 24 rotates beyond a designed position in the YZ-plane during the process of combining the front conductive member 242 with the rear conductive member 244. As described above, the structure 10B can be easily made and can be reduced in height by providing the contact portion 214B of a simple cylindrical shape.

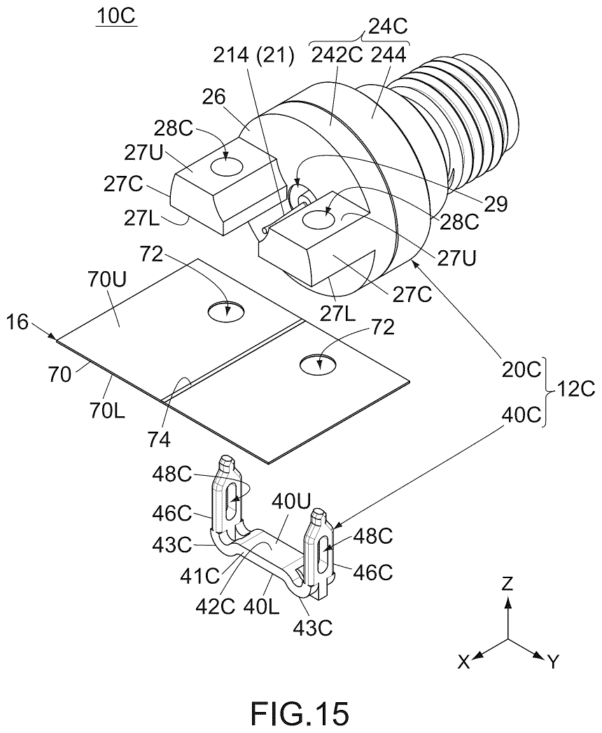

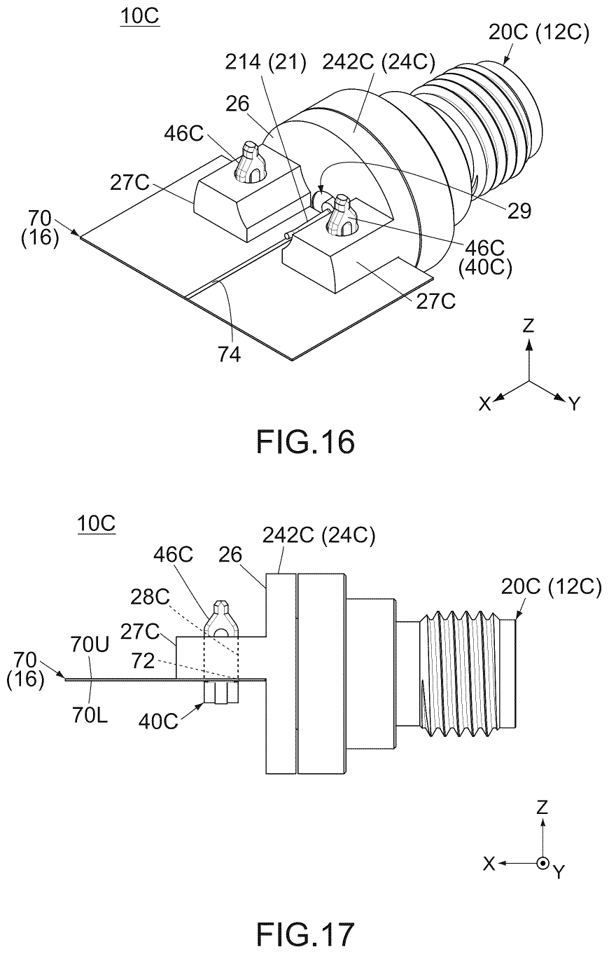

Comparing FIG. 15 with FIG. 1, a structure 10C according to a third modification comprises a connector assembly 12C different from the connector assembly 12 and the flexible board 16 same as that of the structure 10. Comparing FIG. 16 with FIG. 2, the connector assembly 12C is configured to be connected to the flexible board 16 similarly to the connector assembly 12.

Comparing FIG. 15 with FIG. 1, the connector assembly 12C comprises a coaxial connector 20C different from the coaxial connector 20 and a connection member 40C which is not provided to the connector assembly 12. The connection member 40C is a single metal plate with bends. The connection member 40C according to the present modification has a predetermined portion which works as a fixed member 41C and two portions other than the predetermined portion which work as fixing members 46C. The thus-formed connector assembly 12C comprises the coaxial connector 20C different from the coaxial connector 20, the fixed member 41C different from the fixed member 40 and the two fixing members 46C different from the fixing members 60. Each of the fixed member 41C and the fixing members 46C of the present modification is a part of the connection member 40C. In other words, the fixed member 41C and the two fixing members 46C are integrally formed with each other.

The coaxial connector 20C comprises an outer terminal 24C different from the outer terminal 24. The coaxial connector 20C has the configuration same as that of the coaxial connector 20 except for the outer terminal 24C. The outer terminal 24C has a front conductive member 242C different from the front conductive member 242. The outer terminal 24C has the configuration same as that of the outer terminal 24 except for the front conductive member 242C. The front conductive member 242C has projecting portions 27C different from the projecting portions 27. The front conductive member 242C has the configuration same as that of the front conductive member 242 except for the projecting portions 27C.

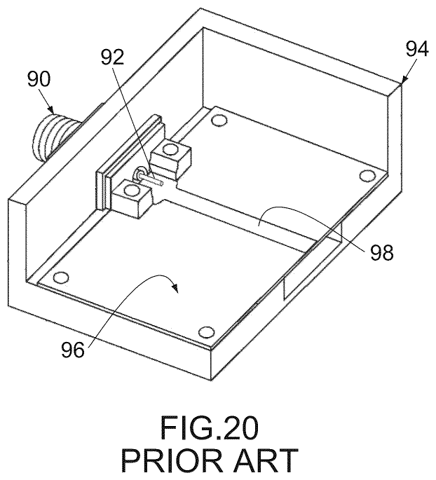

Referring FIG. 19 together with FIG. 6, the coaxial connector 20C is configured to be attached to the front end of the coaxial cable 80. Referring FIG. 19, the coaxial connector 20C comprises the outer terminal 24C, the center terminal 21 and the insulation member 22. The insulation member 22 insulates the outer terminal 24C and the center terminal 21 from each other. As shown in FIG. 15, the outer terminal 24C has the end surface 26 and the two projecting portions 27C. The two projecting portions 27C are apart from each other in the lateral direction and project forward from the end surface 26.

Each of the projecting portions 27C is formed with a press-fit hole 28C. The coaxial connector 20C is formed with the press-fit holes 28C instead of the screw holes 28. The coaxial connector 20C has the configuration same as that of the coaxial connector 20 except for this difference. Each of the press-fit holes 28C of the present modification passes through the projecting portion 27C in the up-down direction. The press-fit holes 28C are provided at positions which correspond to those of the passing holes 72 of the flexible board 16 in the horizontal plane, respectively. The thus-arranged two press-fit holes 28C are apart from each other in the lateral direction and are located at positions same as each other in the front-rear direction. Moreover, the number of the press-fit holes 28C of the present modification is two. However, the present invention is not limited thereto. For example, each of the projecting portions 27C may be formed with two or more of the press-fit holes 28C. Each of the press-fit holes 28C may be a hole with a ceiling.

The center terminal 21 has the contact portion 214. The contact portion 214 is located between the two projecting portions 27C in the lateral direction and extends forward beyond the end surface 26. In detail, the contact portion 214 extends forward and downward under a pre-connected state where the connector assembly 12C is not yet connected to the flexible board 16 as shown in FIG. 15.

The connection member 40C has a coupling portion (fixed member) 41C, a pressed portion 42C, two arc-like portions 43C and two press-fit portions (fixing members) 46C. According to the present modification, the coupling portion 41C works as the fixed member 41C, and each of the press-fit portions 46C works as the fixing member 46C. In other words, the fixed member 41C of the present modification is the coupling portion 41C, and each of the fixing members 46C of the present modification is the press-fit portion 46C.

The two press-fit portions 46C are located at opposite sides of the connection member 40C in the lateral direction, respectively. The coupling portion 41C couples the two press-fit portions 46C together in the lateral direction. In detail, each of the press-fit portions 46C is connected to the coupling portion 41C via the arc-like portion 43C. Each of the arc-like portions 43C has an arc-like shape which projects downward in the YZ-plane.

The coupling portion 41C extends along the horizontal plane and has an upper surface 40U and a lower surface 40L each of which is a flat surface in parallel to the horizontal plane. According to the present modification, a middle part of the upper surface 40U of the coupling portion 41C in the lateral direction mainly works as the pressed portion 42C. In other words, the fixed member 41C has the pressed portion 42C.

Each of the press-fit portions 46C extends upward beyond the coupling portion 41C. Each of the press-fit portions 46C is formed with a hole portion 48C. Each of the hole portions 48C extends in the up-down direction and passes through the press-fit portion 46C in the lateral direction. Each of the press-fit portions 46C, which is formed with the hole portion 48C, is resiliently deformed so as to be partially compressed in the front-rear direction when receiving a force along the front-rear direction. Each of the press-fit portions 46C, which is resiliently deformed, generates a force directed outward in the front-rear direction because of its restoring force.

Comparing FIG. 17 with FIG. 4, the connector assembly 12C is configured to be connected to the flexible board 16 not by the connection method of the connector assembly 12 in which the screws 60 are screwed but by another connection method in which the press-fit portions 46C are press-fit.

In detail, when the connector assembly 12C is connected to the flexible board 16, each of the press-fit portions 46C is inserted into the press-fit hole 28C of the coaxial connector 20C through the passing hole 72 of the flexible board 16. Each of the press-fit holes 28C has a size in the front-rear direction which is smaller than another size of the press-fit portion 46C in the front-rear direction. Accordingly, each of the press-fit portions 46C is inserted into the press-fit hole 28C while being compressed in the front-rear direction. The press-fit portion 46C received in each of the press-fit holes 28C is pressed against an inner wall surface of the press-fit hole 28C by its restoring force. As a result, the connection member 40C is fixed to the coaxial connector 20C, and the connector assembly 12C is connected to the flexible board 16.

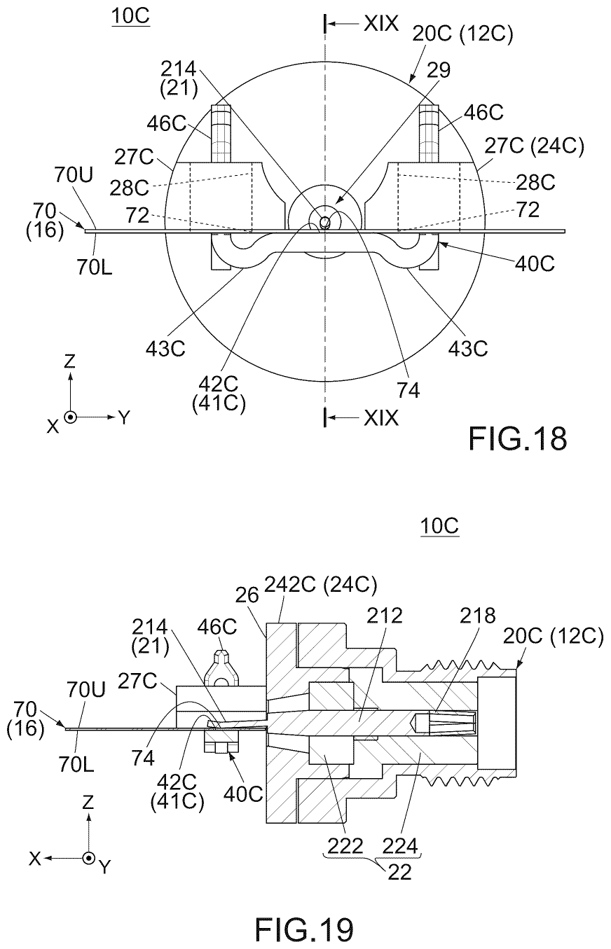

Referring FIG. 18, the fixed member 41C of the connection member 40C is located below the flexible board 16 under a connected state where the connector assembly 12C is connected to the flexible board 16. Under the connected state, the two fixing members 46C of the connection member 40C are fixed to the two projecting portions 27C of the outer terminal 24C through the two passing holes 72 of the flexible board 16, respectively, while pressing the pressed portion 42C of the fixed member 41C against the lower surface 70L of a part of the flexible board 16 on which the signal line 74 is formed, and thereby the contact portion 214 of the center terminal 21 is pressed against and is brought into contact with the signal line 74 of the flexible board 16.

The present modification, similarly to the previously described embodiment, provides a configuration in which the coaxial connector 20C is connected to the flexible board 16 and which enables high contact reliability between the center terminal 21 and the signal line 74.

According to the present modification, each of the press-fit portions 46C is press-fit into the press-fit hole 28C through the passing hole 72 of the flexible board 16 under the connected state. The connection method using the press-fitting can be easily performed in a short time in comparison with the connection method using the screwing.

When the two arc-like portions 43C is pressed upward during the process of press-fitting the press-fit portions 46C into the press-fit holes 28C, the arc-like portions 43C are resiliently deformed, and thereby the pressed portion 42C receives an upward force. According to this mechanism, the contact reliability between the center terminal 21 and the signal line 74 can be further improved. However, the present invention is not limited thereto. For example, the arc-like portions 43C may be provided as necessary.

The connector assembly 12C forms the structure 10C together with the flexible board 16 connected thereto. The flexible board 16 of the structure 10C is located between the projecting portions 27C of the outer terminal 24C and the fixed member 41C in the up-down direction. The signal line 74 of the flexible board 16 is pressed by the fixed member 41C from below and is pressed against the contact portion 214 of the center terminal 21.

Referring FIG. 15 together with FIG. 8, the structure 10C may comprise the flexible board 16A instead of the flexible board 16. However, no specific effects can be obtained unless the fixed member 41C is provided with a part such as the upward protruding pressed portion 42A of the fixed member 40A.

Although the embodiment and various modifications are described above, the previously described embodiment and modifications can be further variously modified and can be variously combined together.

What is claimed is:

1. A connector assembly configured to be connected to a flexible board, wherein:
the flexible board extends along a horizontal plane, the flexible board being formed with two passing holes, each of the passing holes passing through the flexible board in an up-down direction perpendicular to the horizontal plane, the flexible board having an upper surface which is formed with a signal line, the signal line extending in a front-rear direction perpendicular to the up-down direction and being located between the two passing holes in a lateral direction perpendicular to both the up-down direction and the front-rear direction;
the connector assembly comprises a coaxial connector, a fixed member and two fixing members;
the coaxial connector is configured to be attached to a front end of a coaxial cable;
the coaxial connector comprises an outer terminal, a center terminal and an insulation member;
the insulation member insulates the outer terminal and the center terminal from each other;
the outer terminal has an end surface and two projecting portions;
the two projecting portions are apart from each other in the lateral direction and project forward from the end surface;
the center terminal has a contact portion;
the contact portion is located between the two projecting portions in the lateral direction and extends forward beyond the end surface;
the fixed member has a pressed portion;
the fixed member is located below the flexible board under a connected state where the connector assembly is connected to the flexible board; and
under the connected state, the two fixing members are fixed to the two projecting portions of the outer terminal through the two passing holes of the flexible board, respectively, while pressing the pressed portion of the fixed member against a lower surface of a part of the flexible bard on which the signal line is formed, thereby the contact portion of the center terminal being pressed against and being brought into contact with the signal line of the flexible board.

2. The connector assembly as recited in claim 1, wherein:
the fixed member is formed with two fixing holes;
each of the fixing holes passes through the fixed member in the up-down direction;
the pressed portion is located between the two fixing holes in the lateral direction;
each of the fixing members is a screw;
each of the projection portions is formed with a screw hole; and
each of the fixing members is screwed into the screw hole through the fixing hole of the fixed member and the passing hole of the flexible board under the connected state.

3. The connector assembly as recited in claim 1, wherein:
the fixed member and the two fixing members are integrally formed with each other;
each of the fixing members is a press-fit portion;
each of the projecting portions is formed with a press-fit hole; and
each of the fixing members is press-fit into the press-fit hole through the passing hole of the flexible board under the connected state.

4. The connector assembly as recited in claim 1, wherein the pressed portion protrudes upward.

5. The connector assembly as recited in claim 1, wherein the contact portion of the center terminal has a fan shape in a plane perpendicular to the front-rear direction.

6. The connector assembly as recited in claim 1, wherein the contact portion of the center terminal extends forward and downward under a pre-connected state where the connector assembly is not yet connected to the flexible board.

7. A structure comprising the connector assembly and the flexible board as recited in claim 1, wherein:
the flexible board is located between the projecting portions and the fixed member in the up-down direction; and
the signal line of the flexible board is pressed by the fixed member from below and is pressed against the contact portion of the center terminal.

8. The structure as recited in claim 7, wherein:
the flexible board is formed with two slits;
the two slits are apart from each other in the lateral direction;
each of the slits extends forward from a rear end of the flexible board;
the signal line is located between the two slits in the lateral direction and extends in the front-rear direction; and
the pressed portion of the fixed member is pressed against a part of the flexible board which corresponds to the signal line in the front-rear direction.
